(19) United States
(12) Patent Application Publication
(10) Pub. No.: US 2011/0272273 A1
(43) Pub. Date: Nov. 10, 2011

(54) LANTHANIDE-MEDIATED PHOTOCHEMICAL WATER SPLITTING PROCESS FOR HYDROGEN AND OXYGEN GENERATION

(75) Inventors: Robert Cable, Las Vegas, NV (US); Anthony J. Perrotta, Boalsburg, PA (US)

(73) Assignee: MOLYCORP MINERALS, LLC, Greenwood Village, CO (US)

(21) Appl. No.: 13/103,791

(22) Filed: May 9, 2011

Related U.S. Application Data
(60) Provisional application No. 61/332,396, filed on May 7, 2010.
(60) Provisional application No. 61/348,049, filed on May 25, 2010.
(60) Provisional application No. 61/361,211, filed on Jul. 2, 2010.

(51) Int. Cl. C01B 13/02; B01J 19/12; B82Y 30/00

(52) U.S. Cl. 204/157.41; 423/579; 204/157.51; 204/157.49; 977/902

(57) ABSTRACT

The application generally relates to a process for generating hydrogen, oxygen or both from water. More particularly, the application generally relates to a lanthanide-mediated photochemical process for generating hydrogen, oxygen or both from water.

### CROSS REFERENCE TO RELATED APPLICATIONS

The present application claims the benefits of U.S. Provisional Application Ser. Nos. 61/332,396 filed May 7, 2010, 61/348,049 filed May 25, 2010 and 61/361,211, filed Jul. 2, 2010, all entitled “Lanthanide-Mediated Photochemical-Catalytic Water Splitting Process for Hydrogen Generation, the entire contents of each is incorporated herein by this reference.

### FIELD OF INVENTION

This disclosure relates generally to a process for generating hydrogen, oxygen or both from water, more particularly to a lanthanide-mediated photochemical process for generating hydrogen, oxygen or both from water.

### BACKGROUND OF THE INVENTION

Numerous processes exist for producing hydrogen and oxygen from water. For example, hydrogen is industrially produced from water by many processes.

The most widely practiced industrial process for producing hydrogen is steam reformation of organic compounds. However, steam reformation from a hydrocarbon feed stream produces large volumes of carbon dioxide as a by-product. As such, steam reformation is an unfavorable industrial process for hydrogen production.

Electrolysis of water to generation hydrogen is another industrial process. While producing neither carbon dioxide nor requiring a hydrocarbon feed stream, the electrolysis of water requires a substantially large amount of electrical energy to generate hydrogen. The large amounts of electrical energy can be expensive and can have a large environmental overhead.

Yet another process for producing hydrogen is a thermochemical process. The thermochemical process produces hydrogen from a solid phase, gaseous phase or supercritical fluid phase reaction. Solar energy can be used as the thermal energy source. However, the thermochemical reactions typically require temperatures exceeding 500 degrees Celsius, and even more typically exceeding 1000 degrees Celsius. Furthermore, many of the thermochemical processes include highly corrosive reactants and/or products. The solid phase thermochemical reactions may be further complicated by a need to preserve nanocrystalline states throughout the reaction or with a need to dissolve a solid phase formed during the reaction. Moreover, thermochemical processes can include multiple phase separation or purification stages. Many thermochemical processes' reactive interfaces can be impaired by passivation of the interface.

A photo-catalytic process can produce hydrogen, oxygen or both from water. Oxygen is produced by a photo-catalytic oxidation of water, and hydrogen is produced by photo-catalytic reduction of water. The oxidation and reduction processes can involve homogenous and/or heterogeneous catalysis. The catalytic systems, while exhibiting good activities, often require expensive reagents, complex nano-structured solids, and/or sacrificial oxidants or reductants other than water.

A need exists for generating one or both of hydrogen and oxygen from water that requires only water and/or light and is substantially free of expensive sacrificial reagents, high temperatures an/or pressures, and/or large electrical overpotentials.

### SUMMARY OF THE INVENTION

These and other needs are addressed herein by various embodiments and configurations. This disclosure generally relates to the generation of hydrogen and, more specifically to the generation of one or both of hydrogen and oxygen from water.

Some embodiments include contacting a first metal-solute species with a catalyst, the contacting of the first metal-solute species with the catalyst forms oxygen gas and a reduced form of the first metal-solute species. The catalyst may be an electrically conductive catalyst (that is a catalysis that conducts electrons), a homogenous catalyst (that is a catalyst is substantially soluble in the reaction mixture), a heterogeneous catalyst (that is s catalyst is substantially insoluble in the reaction mixture), an organometallic catalyst, an organic catalyst, or a combination thereof. The contacting may be conducted at a temperature of no more than about 100 degrees Celsius. Preferably, the contacting is conducted at a temperature of no more than about 50 degrees Celsius.

Other embodiments include applying electromagnetic energy having a wavelength from about 25 nm to about 1000 nm to a second metal-solute solution to form hydrogen gas and an oxidized form of the second metal-solute solution. At least some of the electromagnetic energy is absorbed by the second metal-solute solution. Preferably, the wavelength of the electromagnetic energy is from about 100 to about 325 nm. A laser may provide the electromagnetic energy.

Yet other embodiments include contacting, in a first compartment, a first metal-solute species with a catalyst, the contacting of the first metal-solute species with the catalyst forms oxygen gas and a reduced form of the first metal-solute species, and applying, in a second compartment, a plurality of photons to second metal-solute species, to form hydrogen gas and an oxidized form of the second metal-solute species. Furthermore, the reduced form of the first metal-solute species formed in the first compartment can be provided to the second compartment. Moreover, the oxidized form of the second metal-solute species formed in the second compartment can be provided to the first compartment. One or both of the contacting and applying steps may be conducted at a temperature of no more than about 100 degrees Celsius. Preferably, at least one of contacting and applying steps is conducted at a temperature of no more than about 50 degrees Celsius. Furthermore, some embodiments may include separating the catalyst from the hydrogen gas and the second metal-solute. The plurality of photons commonly have a wavelength from about 25 nm to about 1000 nm, more commonly a wavelength from about 100 to about 400 nm and even more commonly a wavelength from about 200 to about 300 nm.

Preferably, the oxidized form of the second metal-solute species is the first metal-solute species and the reduced form of the first metal-solute species is the second metal-solute species. The first metal-solute species may be one or more of Au³⁺, Pb⁴⁺, Pb²⁺, Ce⁴⁺, Pr⁴⁺, Eu³⁺, Bk⁴⁺, and Cm⁴⁺. The second metal-solute species may be one or more of Au⁺, Pb²⁺, Pb⁰, Ce³⁺, Pr³⁺, Eu²⁺, Bk³⁺ and Cm³⁺. More preferably the first and second metal-solute species is a metal sulfonate. The sulfonate may be one of sulfate, methanesulfonate and a mixture thereof.

In a preferred embodiment, the first metal-solute species is a cerium (IV)-containing sulfonate solution and second metal-solute species is a cerium (III)-containing sulfonate solution. In a more preferred embodiment, the first metal-solute species is cerium (IV) methanesulfonate and the second metal-solute species is cerium (III) methanesulfonate.

Preferably, the catalyst is an electron conductor selected from the group consisting of a platinum group metal-containing material, activated carbon, carbon nano-tubes and mixtures thereof. When the catalyst is a platinum group metal-containing material, the catalyst preferably has a surface area from about 10 m²/g to about 1,000 m²/g. Moreover, when the catalyst is a carbon nano-tube catalyst, the catalyst preferably has a surface area greater than about 200 m²/g. The carbon nano-tubes may be single-walled carbon nano-tubes, multi-walled carbon nano-tubes, or a mixture thereof. Furthermore, the carbon nano-tubes may have a tube diameter from about 1 to about 50 nm or a tube diameter from about 10 to about 30 nm. The catalyst may comprise activated carbon. The activated carbon may have a surface area greater than about 500 m²/g or it may have a surface area greater than about 1,500 m²/g.

A preferred embodiment includes contacting, in a first compartment, a cerium (IV)-containing sulfonate solution with a catalyst, the contacting of the cerium (IV)-containing sulfonate solution with the catalyst forms oxygen gas and cerium (III), and contacting, in a second compartment, a plurality of photons with a cerium (III)-containing sulfonate solution, at least some of the photons are absorbed by the cerium(III)-containing sulfonate solution to form hydrogen gas and cerium (IV). The process may further include one or both of providing the cerium (III) formed in the first compartment to the second compartment and providing the cerium (IV) formed in the second compartment to the first compartment. Preferably, the photons have a wavelength from about 25 nm to about 1,000 nm. More preferably, the photons have a wavelength from about 100 nm to about 325 nm.

These and other advantages will be apparent from the disclosure of the invention(s) contained herein.

As used herein, the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present invention(s). These drawings, together with the description, explain the principles of the invention(s). The drawings simply illustrate preferred and alternative examples of how the invention(s) can be made and used and are not to be construed as limiting the invention(s) to only the illustrated and described examples.

Further features and advantages will become apparent from the following, more detailed, description of the various embodiments of the invention(s), as illustrated by the drawings referenced below.

FIG. 1 depicts the ultra-violet visible absorption spectrum for cerium (III) and cerium (IV) metal-solute species.

FIG. 2 depicts a method for conducting some embodiments;

FIG. 3 depicts another method for conducting some embodiments;

FIG. 4 depicts yet another method for conducting other embodiments; and

FIGS. 5A and 5B show a gas chromatography analysis of atmospheres above a 0.15 M Ce₂(SO₄)₃ in 0.35 N sulfuric acid solution before and after irradiation of the solution with an ultra-violet laser.

### DETAILED DESCRIPTION OF THE INVENTION

One embodiment is a chemical oxidation process using a metal-solute species. The chemical oxidation process comprises a solution containing a first reactant and a first metal-solute species. The first metal-solute species can mediate the oxidation process. The first reactant can be any chemical species capable of being oxidized in the oxidation process. Preferably, the first reactant is water and the oxidation process produces molecular oxygen gas. More preferably, the oxidation process is a mediated oxidation process producing molecular oxygen gas from water. The first metal-solute species is preferably reduced in the oxidation process. The oxidation process can further include a catalyst. The catalyst is preferably an electron conductor.

Another embodiment is chemical reduction process using a metal-solute species. The chemical reduction process comprises a solution containing a second reactant and a second metal-solute species. The second metal-solute species can mediate the reduction process. The second reactant can be any chemical species capable of being reduced in the reduction process. Preferably, the second reactant comprises a proton or protonated water and the reduction process produces molecular hydrogen gas. The reduction process is preferably conducted in acidic solution. The acidic solution may be strongly acidic or weakly acidic. That is the acidic solution may have pH of less than about pH 0, less than about pH 1, less than about pH 2, less than about pH 3, less than about pH 4, less than about pH 5, less than about pH 6, or less than about pH 7. It can be appreciated that under some conditions the reduction may be conducted in solutions having a pH of more than pH 7. More preferably, the reduction process is a metal-solute mediated reduction process producing hydrogen from protonated water. The second metal-solute species is preferably oxidized in the reduction process. In some embodiments, the reduction process can comprise a catalytic reduction process for producing hydrogen from protonated water. In some embodiments, electromagnetic energy is applied to the solution containing the second reactant and second metal-solute species.

Yet another embodiment is a cyclic process using a metal-solute species. The cyclic process comprises an oxidation portion and a reduction portion. It can be appreciated that the oxidation portion substantially comprises the oxidation process and the reduction portion substantially comprises the reduction process. The metal-solute species can mediate one or both of the oxidation and reduction processes. In the oxidation portion, an oxidized form of the metal-solute species oxidizes a first reactant and the oxidized form of the metal-solute is reduced to form a reduced species of the metal-solute. The oxidized form of the metal-solute is referred to herein as the first metal-solute species. The reduced form of the metal-solute species is referred to herein as the second metal-solute species. In the reduction portion, the reduced form of the metal-solute species (that is, the second metal-solute species) reduces a second reactant and the reduced form of the metal-solute species is oxidized to form an oxidized form of the metal-solute (that is, the first metal-solute species). The first metal-solute species produced in the reduction portion of the cycle can be provided to the oxidation portion of the cycle and the second metal-solute species produced in oxidation cycle can be provided to the reduction portion of the cycle. The first and second reactants can be the same or differ. The oxidation portion can further include a catalyst. The catalyst can comprise an electron conductor. The reduction portion can further include applying electromagnetic energy.

In some embodiments, the first and second reactants can be a material that is capable of being oxidized and/or reduced. Water is an example of a material that is capable of being oxidized (to form oxygen gas) and reduced (to form hydrogen gas).

In other embodiments, the first and second reactants can be separate and distinct materials. For example, the first reactant can be selected for selective removal of the first reactant from a process stream or for formation of oxidized form of the first reactant Likewise, the second reactant can be selected for selective removal of the second reactant from a process stream or for formation of a reduced form of the second reactant.

The metal-solute species preferably comprises an element selected from the group 4-15, lanthanide or actinide metals. The metal can be any metal having first and second oxidation states, the first oxidation being greater (or higher) than the second oxidation state. The second metal-solute species has a lesser (or lower) oxidation state than the first metal-solute species. Preferably, the first and second metal-solute species, respectively, comprise two differing oxidation states of the same metal.

In a preferred embodiment, the metal-solute metals have an oxidation potential of at least about 1.1 volts versus a standard hydrogen electrode under standard thermodynamic conditions. Typically, the metals are members of the IB, IVA and IIIB groups of the periodic table. The IIIB group comprises the lanthanide and actinide series of elements. As used herein, the lanthanide series refers to a “rare earth”. “Rare earth” refers to one or more of yttrium, scandium, lanthanum, cerium, praseodymium, neodymium, samarium, europium, gadolinium, terbium, dysprosium, holmium erbium, thulium, ytterbium, and lutetium. As used herein, the actinide series refers to one or more of actinium, thorium, protactinium, uranium, neptunium, plutonium, americium, curium, berkelium, californium, einsteinium, fermium, mendelevium, nobelium and lawrencium.

More preferred metals are gold, cerium, praseodymium, europium, berkelium, curium, and lead. Even more preferred metals are gold, lead, cerium, europium, praseodymium, berkelium and curium. Yet even more preferred metals are cerium and lead. An even more preferred metal is cerium.

Preferred first metal-solute species comprise one or more of Au³⁺, Pb⁴⁺, Pb²⁺, Ce⁴⁺, Eu³⁺, Pr⁴⁺, Bk⁴⁺, and Cm⁴⁺. More preferred first metal-solute species are one of Au³⁺, Pb⁴⁺, Pb²⁺, Ce⁴⁺, Eu³⁺, and Pr⁴⁺.

Preferred second metal-solute species comprise one or more of Au⁺, Pb²⁺, Pb⁰, Ce³⁺, Eu²⁺, Pr³⁺, Bk³⁺ and Cm³⁺. More preferred second metal-solute species are one of Au⁺, Pb²⁺, Pb⁰, Ce³⁺, Eu²⁺, and Pr³⁺.

A non-limiting example of a chemical oxidation process is the oxidation of water to produce oxygen gas. The chemical oxidation of water by a metal-solute species to produce oxygen can be depicted by chemical equation (1):

2M^{m+}+H₂O→2Mⁿ⁺+½O₂+2H⁺ (1)

Where ‘M’ represents the metal-solute species and ‘m’ and ‘n’ represent the oxidation states of the metal ‘M’ and ‘m’ is greater than ‘n’. In chemical equation (1), the metal-solute species M^{m+} is reduced in the oxidation process to Mⁿ⁺, while oxygen within water is oxidized to molecular oxygen gas.

A non-limiting example of a chemical reduction process is the reduction of water to produce hydrogen gas. The chemical reduction of water by a metal to produce hydrogen can be depicted by chemical equation (2):

2Mⁿ⁺+2H₃O⁺→2M^{m+}+H₂+2H₂O (2)

In chemical equation (2), the metal-solute species Mⁿ⁺ is oxidized in the reduction process to M^{m+}, while the proton contained in the protonated water species H₃O⁺ is reduced to hydrogen gas.

Yet another embodiment is a cyclic process for producing molecular hydrogen and oxygen from water using a metal-solute mediator. The cyclic process comprises the oxidation process and the reduction process. Preferably, the cyclic process comprises the net reaction of chemical equations (1) and (2), which can be depicted in their combined form as chemical equation (3):

H₂O→½O₂+H₂ (3)

In the combined form of chemical equations (1) and (2), the metal-solute species functions as a mediator and, therefore, while participating in the chemical reactions (1) and (2), the metal-solute species is not depicted in the overall chemical reaction (3). The metal-solute species is neither consumed nor produced in the over-all chemical reaction. In the oxidation portion, that is chemical equation (1), the first metal-solute species is reduced to form the second metal-solute species and in reduction portion, that is chemical equation (2), the second metal-solute species is oxidized to form the first metal-solute species.

It can be appreciated that while various embodiments depict water as being oxidized and reduced to generate, respectively, oxygen and hydrogen gas, using a metal-solute species, the chemical substance being oxidized and/or reduced is not limited to water nor exclusively to the generation of oxygen and/or hydrogen gas. For example, the chemical species can be an organic or inorganic substance.

While not wanting to be limited by example, the organic substance can comprise an alkaline being oxidized to one or more of an alkene, alcohol, alkyl halide, amine, alkyne, ketone, aldehyde, geminal diol, carboxylic acid, amide, alkyl di-halide, alkyl tri-halide carbon dioxide, tetrahalomethane; one more of an alkene, alcohol, alkyl halide or amine oxidized to one more of alkyne, ketone, aldehyde, geminal diol, carboxylic acid, amide, alkyl di-halide, alkyl tri-halide carbon dioxide, tetrahalomethane; one or more of an alkyne, ketone, aldehyde, geminal diol, or alkyl di-halide oxidized to one more of carboxylic acid, amide, alkyl tri-halide carbon dioxide, or tetrahalomethane; or one or more of carboxylic acid, amides or alkyl tri-halide oxidized to one or both of carbon dioxide and tetrahalomethane. Conversely, the organic substance comprise one or both of carbon dioxide and tetrahalomethane being reduced to one or more of carboxylic acid, amide, alkyl trihalide, alkyne, ketone, aldehyde, geminal diol, alkyl dihalide, aklene, alcohol, alkyl halide, amine, or alkane; one or more of carboxylic acid, amide, or alkyl trihalide being reduced to one or more of alkyne, ketone, aldehyde, geminal diol, alkyl dihalide, aklene, alcohol, alkyl halide, amine, or alkane; one or more of alkyne, ketone, aldehyde, geminal diol or alkyl di-halide being reduced to one or more of aklene, alcohol, alkyl halide, amine, or alkane; one or more of alkene, alcohol, alkyl halide or amine being reduced to an alkane.

The inorganic substance can any substance comprising coordination compounds (such as a central inorganic atom or ion, excluding carbon, bonded to a surrounding array of molecules or ions (commonly referred to as ligands or complexing agents, which can include carbon)), main group compounds (such as, but not limited to compounds comprising elements from groups 1, 2, 13-18 and optionally group 12 of the periodic table), transition metal compounds (such as, but not limited to compounds comprising elements from groups 4-11 and optionally group 12 of the periodic table), organometallic compounds (such as, but not limited to compounds comprising a main group metal from groups 1, 2, 13-18 and optionally group 12) and/or a transition metal (from groups 4-11 and optionally group 12) and a carbon-containing radial; a cluster compound (such as, but not limited to two or more atoms from groups 1, 2, and 4-18 atoms having at least one atom-atom bond, with the exclusion of carbon-carbon bounds within an organic radial); bioinorganic compounds (such as, but not limited to compounds occurring in nature comprising a metal or metalloid—not non-limiting examples include carboxypetidase, methylmercury and hemoglobin), and solid state compounds (such as, metals, alloys, intermetallic materials, and minerals).

In some embodiments, the process comprises a solvation-agent. The solvation-agent can substantially stabilize the metal-solute species in solution. Preferably, the solvation-agent substantially stabilizes one or both of the first and second metal-solute species. The solvation-agent can substantially increase the metal-solute solution concentration, compared to solutions lacking the solvating-agent. While not wanting to be limited by example, one or both of the oxidation and reduction processes can proceed substantially faster for metal-containing solutions having the solvation-agent than in solutions lacking the solvation-agent. Moreover in some instances, one or both of the oxidation and reduction processes are substantially impeded, if not substantially totally impeded, for metal-containing solutions lacking the solvation-agent.

While not wanting to be limited by theory, it is believed that the reaction kinetics of one or both of the oxidation and reduction processes is greater than zero order. That is, the reaction kinetics of the oxidation and/or reduction processes is commonly believed to increase at least linearly with concentration of the metal-solute species. Moreover, the reaction kinetics of the oxidation and/or reduction process is believed to more commonly increase exponentially with concentration, even more commonly the kinetics of the oxidation and/or reduction process is believed to increase according to the metal-solute concentration raised to the power ‘n’, where ‘n’ is real positive number. Therefore, increasing the metal-solute concentration, through a solvation-agent, substantially increases one or both of the oxidation and/or reduction process, at least linearly, if not exponentially.

In some embodiments, the solvation-agent increases the metal-solute concentration above the concentration for the metal in the absence of the solvation-agent. It can be appreciated that, the oxidation state of the metal can vary the metal-solute concentration. For example, the molar concentration of cerium for cerium(IV) iodate is about 2×10⁻⁴ M while for cerium(III) iodate the molar concentration of cerium is about ten times greater, that is, 2×10⁻³ M.

Furthermore, for a specific oxidation state, the solvation-agent can increase the metal-solute concentration for the metal in the absence of the solvation-agent. More specifically, for a given metal-containing composition the solvation-agent can increase the concentration of the metal in solution at least about 1.5 times, at least about 1.6 times, at least about 1.8 times, at least about 2 times, at least about 4 times, at least about 6 times, at least about 8 times, at least about 10 times, at least about 25 times, at least about 50 times, at least about 100 times, at least about 250 times, at least about 500 times, at least about 1000 times compared to a metal solution lacking the solvation-agent.

While not wanting to be limited by example, sulfuric acid can substantially increase the solubility of cerium (III) from about 0.1 M cerium (III) in water the absence of sulfuric acid to about 0.2 M cerium (III) in the water in the presence of sulfuric acid. Moreover, methanesulfonic acid can substantially increase the solubility of cerium (III) from about 0.1 M cerium (III) in water in the absence of methanesulfonate to about 4 M cerium (III) in the water in the presence of methanesulfonate.

Similarly, sulfuric acid can substantially increase the solubility of cerium (IV) from about 1×10⁻³ M cerium (IV) in water the absence of sulfuric acid to about 0.1 M cerium (IV) in the water in the presence of sulfuric acid. Moreover, methanesulfonic acid can substantially increase the solubility of cerium (IV) sulfate in from about 0.1 M cerium (IV) in water the absence of methanesulfonate to about 4 M cerium (IV) in the water in the presence of methanesulfonate.

In some instances, the metal-solute species can have retrograde solubility. One such system retrograde system is cerium dissolved in sulfuric acid. For example, cerium solubility in sulfuric acid can be less at higher temperatures than at lower temperatures. Preferably, for metal-solute systems having retrograde solubility, the oxidation and/or reduction process should be at a temperature that does not significantly reduce metal-solute solution concentration. More specifically, the oxidation and/or reduction process temperature(s) should be sufficiently high to increase the kinetics of the oxidation and/or reduction reaction kinetics without significantly reducing the metal-solute concentration(s).

Non-limiting examples of solvation-agents comprise sulfuric acid, sulfonates, phosphonates, chelating-agents (or sequestering-agents) and mixtures thereof. The sulfonate can be any RSO₂O⁻, (that is, R—(S═O)₂O⁻), where R is an organic radical. Preferably, the sulfonate is one or more of methanesulfonate, trifluoromethanesulfonate, p-toluenesulfonate, benzenesulfonate, or a mixture thereof. The organophosphonic acids can be any R—P(═O)(OH)₂, (or, R—(P═O)O₂⁻ anions), where R is an organic radical. Preferably, the organophosphonic acid is one of methyl, ethyl, propyl, isopropyl, ethylenediamine(tetramethylene), hexamethylenediamine(tetramethlen), hexamethylenediamine(tetramethylen), or ethlenediamine(pentamethylene) phosphonic acid or a mixture thereof. Furthermore, the chelating-agent can be bi-, tri-, tetra-, penta- or hexa-valent agents. By way of example, the chelating-agent can be ethylenediamine, ethylenediamainetriacetic acid (or acetate), triethylenetetramine, diethylenetriamine, ethylenediaminetetraacetic acid (or acetate), tris(2-aminoethyl)amine, 1,4,7,10-tetraazacyclododecane-1,4,7,10-tetraacetate, diethylenetriaminepentaacetate, 1,4,7-triazacyclonane, 1,4,7-trithiacyclonane, and mixtures thereof.

Some of the advantages of the oxidation process, reduction process and/or the cyclic process may preferably include one or more of: commonly operating a temperature from about 15 to about 100 degrees Celsius; commonly operating at ambient pressures; typically lacking and/or being devoid of a precipitation process; typically lacking and/or being devoid of a dissolution process; substantially lacking or being devoid of carbon dioxide and/or greenhouse gas emissions; typically lacking and/or being devoid of sacrificial reagents other than the first and/or second reactant; substantially lacking or being devoid of large energy requirements; commonly forming oxidation and reduction products separately, thereby simplifying their separation, that is, hydrogen and oxygen can be formed separately, thereby simplifying their separation; and typically lacking and/or being devoid of one or both of substantially corrosion and hazardous chemicals.

### Reduction Process

As used herein the reduction process refers to the reduction of the second reactant by the second metal-solute species. The second metal-solute species can mediate the reduction process. Furthermore, the second metal-solute species is oxidized in the reduction process.

The reduction process can proceed with or without application of one or both of thermal and electromagnetic energies. In some embodiments, the reduction process proceeds without the application of thermal energy. Preferably, the reduction process proceeds at ambient temperature, without the application of thermal energy. In other embodiments, thermal energy may be applied to the solution during the reduction process. In yet other embodiments, electromagnetic energy is applied to one or both of the solution and second metal-solute species during at least some of the reduction process.

Thermal energy may be applied during at least some of the reduction process. The thermal energy applied is sufficient to heat the solution to a temperature of no more than about 30 degrees Celsius, to a temperature of no more than about 40 degrees Celsius, to a temperature of no more than about 50 degrees Celsius, to a temperature of no more than about 60 degrees Celsius, to a temperature of no more than about 70 degrees Celsius, to a temperature of no more than about 80 degrees Celsius, to a temperature of no more than about 90 degrees Celsius, or to a temperature of no more than about 100 degrees Celsius. In some embodiments, the thermal energy applied is sufficient to heat the solution to a temperature of no more than about 110 degrees Celsius, to a temperature of no more than about 120 degrees Celsius, to a temperature of no more than about 130 degrees Celsius, to a temperature of no more than about 150 degrees Celsius, to a temperature of no more than about 170 degrees Celsius, or to a temperature of no more than about 200 degrees Celsius. It can be appreciated that the increase in temperature can increase one or both of the rate of the reduction process and the solution concentration of the first metal-solute species. In some embodiments, the increase in temperature may also increase the first reactant solution concentration. In other embodiments, the increase in temperature may increase one or both of second metal-solute concentration and the solubility of the first metal-solute formed during the reduction process.

Preferably, the second metal-solute has a solution concentration of at least about 0.001 M, a solution concentration of at least about 0.005 M, a solution concentration of at least about 0.01 M, a solution concentration of at least about 0.05 M, a solution concentration of at least about 0.1 M, a solution concentration of at least about 0.25 M, a solution concentration of at least about 0.5 M, a solution concentration of at least about 0.75 M, a solution concentration of at least about 1 M, a solution concentration of at least about 2 M, a solution concentration of at least about 3 M, or a solution concentration of at least about 4 M. More preferably, the second metal-solute comprises cerium (III) at one of the above first metal-solute concentrations. Even more preferably, the cerium (III) first metal-solute comprises Ce (III) sulfate, Ce (III) methanesulfonate, or mixture thereof at one of the about second metal-solute concentrations, respectively, in sulfuric acid, methansulfonic acid or combination thereof.

Preferably, the electromagnetic energy is applied for at least some period of time during the reduction process. The electromagnetic energy is selected from the group of microwave energy (typically having a wavelength of about 10⁻² m and/or a frequency from about 10⁹ to about 10¹¹ Hz), infrared energy (typically having a wavelength of about 10⁻⁵ m and/or a frequency from about 10¹¹ to about 10¹⁴ Hz), visible light energy (typically having a wavelength of about 0.5×10⁻⁶ m and/or a frequency from about 10¹⁴ to about 10¹⁵ Hz), ultraviolet energy (typically having a wavelength of from about 10⁻⁷ to about 10⁻⁹ m and/or a frequency from about 10¹⁵ to about 10¹⁷ Hz), and x-ray energy (typically having a wavelength of about 10⁻¹⁰ m and/or a frequency from about 10¹⁷ to about 10¹⁹ Hz). Preferably, the electromagnetic energy is ultraviolet energy. More preferably, the electromagnetic energy has a wavelength from about 1×10⁻⁹ m to about 2,000×10⁻⁹ m, a wavelength from about 5×10⁻⁹ m to about 1,000×10⁻⁹ m, a wavelength from about 25×10⁻⁹ m to about 750×10⁻⁹ m, a wavelength from about 50×10⁻⁹ m to about 500×10⁻⁹ m, a wavelength from about 100×10⁻⁹ m to about 450×10⁻⁹ m, and a wavelength from about 150×10⁻⁹ m to about 350×10⁻⁹ m.

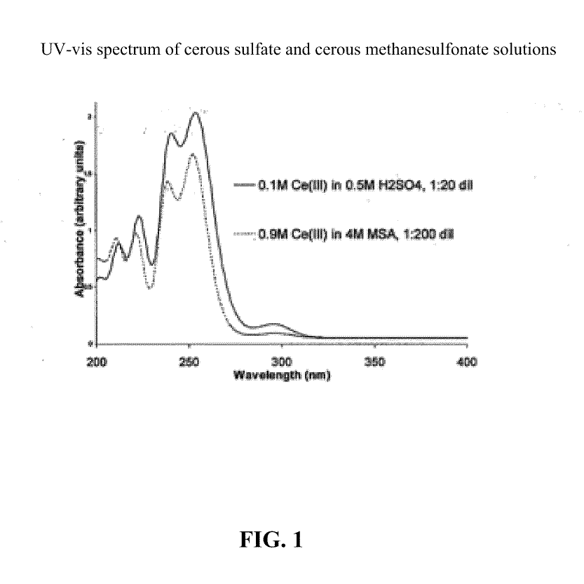

The electromagnetic energy applied preferably corresponds with the ultra-violet visible absorption spectrum of one or both of cerium (III) and cerium (IV) as depicted in FIG. 1. The ultra-violet visible region of the electromagnetic spectrum generally corresponds to electromagnetic energies from about 25 nm to about 1,000 nm. More preferably, the electromagnetic energy has a wavelength from about 200 nm to about 325 nm, has a wavelength from about 200 nm to about 275 nm, has a wavelength from about 225 nm to about 275 nm, has a wavelength from about 235 nm to about 265 nm, has a wavelength from about 240 nm to about 360 nm, or has a wavelength of about 250 nm.

In some embodiments, the electromagnetic energy may be applied continuously during the reduction process, may be applied intermediately during the reduction process, or may be applied continuously in an intermediate manner (such as, continuously applied in a pulsed manner) during the reduction process. The pulsed manner can have a regulated pattern (such as, a substantially regular, repeating pattern or frequency) or can have an unregulated pattern (such as, a substantially irregular, non-repeating pattern or frequency).

The electromagnetic energy may be provided as solar energy (that is from the sun), by a laser, by lamp or a combination thereof. Non-limiting examples of lamps are arc, incandescent and discharge. Preferably, the lamp is a discharge lamp. More preferably, the lamp is one of a plasma, induction, low-pressure, high-pressure, noble gas discharge, sodium vapor discharge, mercury vapor discharge, metal-halide vapor discharge, xenon vapor discharge, or combination thereof. The laser may be one of a gas, chemical, excimer, solid-state, fiber, photonic, semi-conductor, dye or free-electron laser operate in one of continuous or pulsed form. In some embodiments, the laser commonly has an average power of at least about 1 Watt, more commonly at least about 10 Watts, even more commonly has an average power at least about 100 Watts, yet even more commonly has an average power at least about 250 Watts, still yet even more commonly has an average power at least about 500 Watts, still yet even more commonly has an average power at least about 1,000 Watts, still yet even more commonly has an average power at least about 2,000 Watts, still yet even more commonly has an average power at least about 4,000 Watts, still yet even more commonly has an average power at least about 6,000 Watts, still yet even more commonly has an average power at least about 8,000 Watts, still yet even more commonly has an average power at least about 10,000 Watts, still yet even more commonly has an average power at least about 20,000 Watts, still yet even more commonly has an average power at least about 50,000 Watts, or still yet even more commonly has an average power at least about 90,000 Watts. In other embodiments, the laser commonly has a peak power of at least about 10³ Watts, more commonly at least has a peak power of about 10⁴ Watts, even more commonly has a peak power of at least about 10⁵ Watts, yet even more commonly has a peak power of at least about 10⁶ Watts, still yet even more commonly has a peak power of at least about 10⁷ Watts, still yet even more commonly has a peak power of at least about 10⁸ Watts, still yet even more commonly at has a peak power of least about 10⁹ Watts, still yet even more commonly has a peak power of at least about 10¹⁰ Watts, still yet even more commonly has a peak power of at least about 10¹¹ Watts, or still yet even more commonly at least about 10¹² Watts.

It can be appreciated that when the reduction process includes applying electromagnetic energy, the process is conducted in a vessel having at least some transmittance to the electromagnetic energy. The vessel may have an aperture and/or at least a portion of the vessel that transmits the electromagnetic energy. The vessel, aperture or at least portion of the vessel having transmittance to the electromagnetic energy, transmits least about most, at least about 90%, at least about 95%, at least about 99%, or at least about 99.5% of the electromagnetic energy. Furthermore, the path of the electromagnetic energy is configured to have at least some, if not most, of the electromagnetic energy absorbed by the second metal-solute. In some configurations, the at least some, if not most, of the electromagnetic energy is transmitted or transferred directly and/or indirectly by from one metal-solute species to another metal-solute species.

In some embodiments, the reduction process is carried-out in a vessel further having one or more reflective surfaces. The reflective surfaces substantially reflect the electromagnetic energy throughout the solution contained within the vessel on all interior surfaces to maximize absorption of electromagnetic energy by the second metal-solute species.

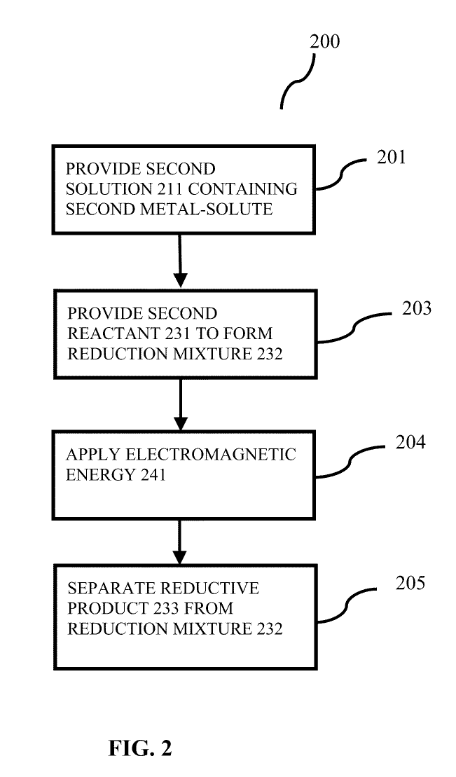

FIG. 2 depicts a method for carrying out a reductive process 200.

In step 201, a second solution 211 containing a second metal-solute species 212 is provided. Preferably, the second metal-solute species 212 is one of the metal-solute species indicated above. More preferably, the second metal-solute species is one of cerium (III) sulfate and cerium (III) methanesulfonate, respectively, in at least one of sulfuric acid and methanesulfonic acid.

In step 203, a second reactant 231 is provided. The second reactant 231 is contacted with the second metal-solute species 212. The second metal-solute species 212 and the second reactant 231 form a reduction mixture 232.

In some embodiments, steps 201 and 203 can be combined into a single step of providing the second metal-solute species 212 and second reactant 212. For example, when the second metal-solute species 212 comprises an aqueous solution, the second reactant 231 (that is water) is provided with the second metal-solute species 212.

In step 204, may include applying electromagnetic energy 241 to the reduction mixture 232. Preferably, the electromagnetic energy 241 has one of the wavelengths or wavelengths ranges indicated above. More preferably, the electromagnetic energy 241 comprises one or more wavelengths substantially absorbed by the second metal-solute species 212. Even more preferably, the electromagnetic energy 241 comprises one or more wavelengths absorbed by one or both of cerium (III) sulfate and cerium (III) methanesulfonate. Step 204 may further include applying thermal energy to the reduction mixture 232. The contacting of the electromagnetic energy 241 and the optional thermal and energy with the reduction mixture 232 forms a reduction product 233 and an oxidized form of the second metal-solute species 234. Preferably, the second reactant 231 is a proton or a protonated form of water and the reductive product 233 is gaseous molecular hydrogen. The oxidized form of the second metal-solute species 234 preferably, comprises one of the first metal-solute species identified herein. More preferably, the oxidized form of the second metal-solute species 234 is one of cerium (IV) sulfate and cerium (IV) methanesulfonate.

In step 205, the reductive product 233 is separated from the reduction mixture 232. The separation process may include, without limitation, a positive, ambient or negative pressure bleeding off of the atmosphere above the reduction mixture 232 to form a bleed-off stream. The molecular hydrogen gas can be removed from the bleed-off stream by any process known within the art, such as, but not limited to sparging processes, zeolites, gas absorption processes, gas dehydration process, pressure swing adsorption, gas separation membranes, combinations thereof or such to form a concentrated molecular hydrogen stream and an hydrogen-deleted gaseous stream. The hydrogen-deleted gaseous stream may be returned to the reduction process 200 to further sweep molecular hydrogen from the atmosphere about the reduction mixture 232.

### Oxidation Process

As used herein the oxidation process refers to the oxidation of the first reactant by the first metal-solute species. The first metal-solute species mediates the oxidation process. Furthermore, the first metal-solute species is reduced in the oxidation process.

Preferably, the oxidation process proceeds without the application of energy. More preferably, the oxidation process proceeds at room temperature. Even more preferably, the oxidation process proceeds without the application of thermal energy.

In some embodiments, the oxidation process proceeds at substantially ambient temperature. That is, the oxidation process typically proceeds at a temperature from about 2 degrees Celsius to about 50 degrees Celsius, more typically the oxidation process proceeds at a temperature from about 4 degrees Celsius to about 40 degrees Celsius, even more typically the oxidation process proceeds at a temperature from about 10 degrees Celsius to about 30 degrees Celsius, yet even more typically the oxidation process proceeds at a temperature from about 15 degrees Celsius to about 25 degrees Celsius, or still yet even more typically the oxidation process proceeds at a temperature from about 20 degrees Celsius.

In some embodiments, the oxidation process commonly proceeds with or without the application of thermal energy at a temperature of no more than about 100 degrees Celsius, more commonly the oxidation process proceeds a temperature of no more than about 90 degrees Celsius, even more commonly the oxidation process proceeds a temperature of no more than about 80 degrees Celsius, yet even more commonly the oxidation process proceeds a temperature of no more than about 70 degrees Celsius, still yet even more commonly the oxidation process proceeds a temperature of no more than about 60 degrees Celsius, still yet even more commonly the oxidation process proceeds a temperature of no more than about 50 degrees Celsius, still yet even more commonly the oxidation process proceeds a temperature of no more than about 40 degrees Celsius, still yet more commonly the oxidation process proceeds a temperature of no more than about 30 degrees Celsius, even still yet more commonly the oxidation process proceeds a temperature of no more than about 20 degrees Celsius, even still yet more commonly the oxidation process proceeds a temperature of no more than about 15 degrees Celsius, even still yet more commonly the oxidation process proceeds a temperature of no more than about 10 degrees Celsius, even still yet more commonly the oxidation process proceeds a temperature of no more than about 5 degrees Celsius, even still yet more commonly the oxidation process proceeds a temperature of no more than about 4 degrees Celsius, even still yet more commonly the oxidation process proceeds a temperature of no more than about 3 degrees Celsius, or still even yet more commonly proceeds a temperature of no more than about 2 degrees Celsius.

In some embodiments, the thermal energy applied is commonly sufficient to heat the solution to a temperature of no more than about 110 degrees Celsius, more commonly sufficient to heat the solution to a temperature of no more than about 120 degrees Celsius, even more commonly sufficient to heat the solution to a temperature of no more than about 130 degrees Celsius, yet even more commonly sufficient to heat the solution to a temperature of no more than about 150 degrees Celsius, still yet even more commonly sufficient to heat the solution to a temperature of no more than about 170 degrees Celsius, or even still yet even more commonly to heat the solution to a temperature of no more than about 200 degrees Celsius. It can be appreciated that the increase in temperature of the solution can increase one or both of the rate of the reduction process and the solution concentration of the first metal-solute species. In some embodiments, the increase in temperature of the solution may also increase the first reactant solution concentration. In other embodiments, the increase in temperature of the solution may increase one or both of second metal-solute concentration and the solubility of the first metal-solute formed during the reduction process.

Preferably, the first metal-solute typically has a solution concentration of at least about 0.001 M, more typically a solution concentration of at least about 0.005 M, a solution concentration of at least about 0.01 M, a solution concentration of at least about 0.05 M, even more typically a solution concentration of at least about 0.1 M, yet even more typically a solution concentration of at least about 0.25 M, still yet even more typically a solution concentration of at least about 0.5 M, still yet even more typically a solution concentration of at least about 0.75 M, still yet even more typically a solution concentration of at least about 1 M, still yet even more typically a solution concentration of at least about 2 M, still yet even more typically a solution concentration of at least about 3 M, or even still yet more typically a solution concentration of at least about 4 M. More preferably, the first metal-solute comprises cerium (IV) at one of the above first metal-solute concentrations. Even more preferably, the cerium (IV) first metal-solute comprises Ce (IV) sulfate, Ce (IV) methanesulfonate, or mixture thereof, respectively, in sulfuric acid, methanesulfonic acid or combination thereof at one of the about first metal-solute concentrations.

Preferably, the oxidation process occurs in the presence of a catalyst. The catalyst can comprise a platinum group metal-containing material, a lead-containing material, lead oxide-containing material, a lead dioxide-containing material, carbon nanotubes, activated carbon, titanium or a combination thereof. In some embodiments, the platinum group metal-containing material can comprise a platinum group metal foil, a nano-particulate comprising a platinum group metal alone or supported on conductive material (such as carbon nano-tubes or activated carbon), a nano-crystalline material comprising a platinum group metal alone or supported on a conductive material (such as carbon nano-tubes or activated carbon) or a combination thereof. The catalyst may or may not be supported on a support, the support may or may not be electrically conductive.

Preferably, the catalyst comprises nano-particulate material comprising a platinum group metal. While not wanting to be limited by example, the nano-particulate platinum group metal material can have an average particle size from about 0.1 nm to about 200 nm. Preferably, the nano-particulate platinum group metal material can have an average particle size from about 0.5 nm to about 100 nm. Typically, the nano-particulate has an average surface area of at least about 50 m²/g, more typically the nano-particulate has an average surface area of at least about 100 m²/g, even more typically the nano-particulate has an average surface area of at least about 150 m²/g, yet even more typically the nano-particulate has an average surface area of at least about 250 m²/g, yet even more typically the nano-particulate has an average surface area of at least about 350 m²/g, or yet even more typically the nano-particulate has an average surface area of at least about 400 m²/g. The nano-particulate platinum group metal material can comprise non-discrete particulates that may be aggregates of ordered, nano-crystalline domains of the platinum group metal. Furthermore, the nano-particulate platinum group metal may or may not be supported.

More preferably, the catalyst comprises nano-crystalline material comprising a platinum group metal supported on an electrically conductive material, such as, but not limited to activated carbon. Commonly the catalyst comprises from about 1 wt % to about 99 wt % of the nano-crystalline material comprising a platinum group metal, more commonly from about 2 wt % to about 90 wt % of the nano-crystalline material, even more commonly from 2 wt % to about 90 wt % of the nano-crystalline material, yet even more commonly from 3 wt % to about 80 wt % of the nano-crystalline material, still yet even more commonly from 4 wt % to about 60 wt % of the nano-crystalline material, yet still more commonly from 5 wt % to about 40 wt % of the nano-crystalline material, yet still even more commonly from 6 wt % to about 30 wt % of the nano-crystalline material, still yet even more commonly from 7 wt % to about 20 wt % of the nano-crystalline material, still yet even more commonly from 8 wt % to about 15 wt % of the nano-crystalline material, or still yet even more commonly from 9 wt % to about 10 wt % of the nano-crystalline material supported on the electrically conductive material. In some embodiments, the nano-crystalline material comprising a platinum group metal commonly having an average surface area of at least about 1 m²/g, more commonly the nano-crystalline material has an average surface area of at least about 10 m²/g, even more commonly the nano-crystalline material has an average surface area of at least about 50 m²/g, yet even more commonly the nano-crystalline material has an average surface area of at least about 80 m²/g, still yet even more commonly the nano-crystalline platinum material has an average surface area of at least about 100 m²/g, still yet even more commonly the nano-crystalline material has an average surface area of at least about 150 m²/g, or still yet even more commonly the nano-crystalline material has an average surface area at least about 200 m²/g.

In some embodiments, the catalyst includes activated carbon with or without a nanoparticle-based or nano-crystalline material comprising a platinum group metal. The activated carbon, with particle sizes of as small as about 0.5 nm or smaller to as large as about 10 microns or larger, can commonly have an average surface area from about 500 m²/g to about 5,000 m²/g, more commonly the activated carbon can have an average surface area from about 1,000 m²/g to about 2,500 m²/g, even more commonly the activated carbon can have an average surface area from about 1,500 m²/g to about 2,000 m²/g, or yet even more commonly the activated carbon can have an average surface area of about from about 1,800 m²/g.

Other embodiments can include a catalyst comprising carbon nanotubes with or without a nanoparticle-based or nano-crystalline material comprising a platinum group metal. The carbon nanotubes can be single or multi walled carbon nanotubes. Preferably, the carbon nanotubes are multi-walled carbon nanotubes. Typically, the carbon nanotubes have an average outside diameter from about 1 nm to about 100 nm, more typically the average outside diameter is from about 5 nm to about 50 nm, or even more typically the average outside diameter is from about 10 nm to about 30 nm. Commonly the carbon nanotubes have an average surface area greater than about 100 m²/g, more commonly the carbon nanotubes have an average surface area greater than about 1,000 m²/g, or even more commonly the carbon nanotubes have an average surface greater than about 2,000 m²/g.

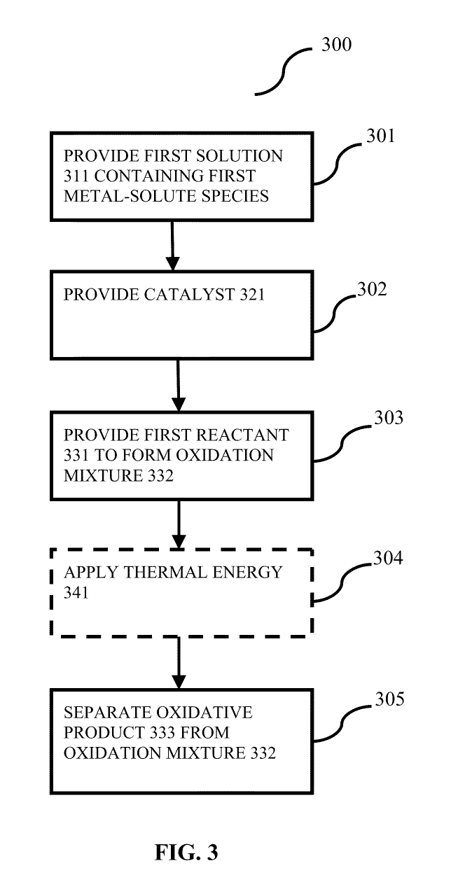

FIG. 3 depicts a method for carrying out an oxidative process 300.

In step 301, a solution 311 containing a first metal-solute species 312 is provided. Preferably, the first metal-solute species 312 is one of the metal-solute species indicated above. More preferably, the first metal-solute species is one of cerium (IV) sulfate and cerium (IV) methanesulfonate, respectively, in at least one of sulfuric acid and methanesulfonic acid.

In step 302, a catalyst 321 is provided. Preferably, the catalyst 321 is one of the catalysts indicated above.

In step 303, a first reactant 331 is provided. The first reactant 331 is contacted with the first metal-solute species 312 and the catalyst 321 to form an oxidation mixture 332. The contacting of the first reactant 331 with the first metal-solute species 312 and the catalyst 321 to form an oxidative product 333 and a reduced form of the first metal-solute species 334. Preferably, the first reactant 331 is water and the oxidative product 333 is gaseous molecular oxygen. The reduced form of first metal-solute species preferably, comprises one of the second metal-solute species identified herein. More preferably, the reduced form of the first metal-solute species is one of cerium (III) sulfate and cerium (III) methanesulfonate.

In some embodiments, steps 301, 302 and 303 may be combined and/or arranged in any manner. For example, the steps may be combined in any order, such as but not limited to: step 301 is preformed before step 302 which is before step 303; step 302 is preformed before step 301 which is before step 303; step 303 is preformed before step 302 which is before step 301; step 302 is preformed before step 301 which is before step 303; step 302 is preformed before step 303 which is before step 30; or step 303 is preformed before step 301 which is before step 302. Furthermore, two or more steps may be combined in any manner, such as but not limited to: steps 301, 302 and 303 may be combined into a single step; steps 301 and 302 may be combined into a single step and the combined step may be performed before or after step 303; steps 301 and 303 may be combined into a single step and the combined step may be performed before or after step 302; or steps 302 and 303 may be combined into a single step and the combined step may be performed before or after step 301.

In optional step 304, thermal energy 341 is applied to one or both of the solution 311 and the oxidation mixture 332. Some embodiment may not require applying thermal energy 341. More specifically, some catalysts may not require applying thermal energy 341. Other catalysts may require applying at least some thermal energy 341.

In step 305, the oxidative product 333 is separated from the oxidation mixture 332. The separation process may include, without limitation, a positive, ambient or negative pressure bleeding off of the atmosphere above the oxidation mixture 332 to form a bleed-off stream containing molecular oxygen. The molecular oxygen can be removed from the bleed-off stream by any process known within the art, such as, but not limited to sparging processes, zeolites, gas absorption processes, gas dehydration process, pressure swing adsorption, gas separation membranes, combinations thereof or such to form a concentrated oxygen stream and an oxygen-deleted gaseous stream. The oxygen-deleted gaseous stream may be returned to the oxidative process 300 to further sweep molecular oxygen from the atmosphere about the oxidation mixture 332.

### Combined Process

The above oxidation and reduction processes can occur in a combined process.

In some embodiments, the combined process can comprise the oxidation and reduction processes being conducted in a single solution. The single solution comprises the first and second reactants and the first and second metal-solute species. The first and second reactants may comprise the same material or differing materials. Preferably, the combined oxidation and reduction processes are occurring simultaneously. However, in some embodiments the oxidation and reduction can occur sequentially, one after the other, such as in a batch process.

In some embodiments, the combined process can comprise the oxidation and reduction processes being conducted as separate and distinct oxidation and reduction processes. Typically, oxidation process occurs in a first vessel and the reduction process occurs in second vessel. Preferably, in the combined process at least one or more species of the oxidation process is passed to the reduction process. Furthermore, at least one or more species of reduction process is preferably passed to the oxidation process. The passing of at least one or more species from the oxidation process to the reduction process and visa-versa will be referred to herein as a cyclic process.

Preferably, the oxidation and reduction processes of the cyclic process occur substantially simultaneously in separate and distinct solutions. That is, the above-described oxidation process occurs in the oxidation solution substantially simultaneously with the occurrence of the reduction processes in the reduction solution. At least one or more species of the reduction process is substantially being passed to the oxidation process at about the same time as the at least one or more species of the oxidation process is being passed to the reduction process.

However, the oxidation and reduction processes can occur sequentially, in some embodiments. That is, one process is performed before, or after, the other process, such as in a batch process. For example, in a batch process the oxidation process can occur before or after the reduction process.

Preferably, the oxidation and reduction solutions are in fluid communication. It can be appreciated that, one or both of the first and second metal-solute species can function as mediators for the cyclic process. Furthermore, for the cyclic process the first and second reactants preferably comprise substantially the same material. In a preferred embodiment, the first and second reactants comprise water.

Moreover, the fluid communication may further include one or more separation processes. The separation processes may include solid liquid separation processes, gas liquid separation processes, ionic separation processes, size exclusion separation processes and combinations thereof.

Some embodiments may include a solid liquid separation process. The solid liquid separation process may include separating the solid catalyst from the oxidation solution containing the second metal-solute species. The solid liquid separation process can be any solid liquid separation process. Non-limiting examples of solid liquid separation processes are filtration, gravitation, centrifugation (including cyclones), flotation, flocculation, precipitation, sedimentation (including gravity) and combinations thereof. The oxidation solution may further comprise any un-reacted second metal-solute species remaining and reduced form of the second metal-species. The reduced form of the second metal-solute (that is, firs metal-solute species) can be preferably transferred to the reduction process and the oxidation solid catalyst is preferably returned to the oxidation process.

Some embodiments may include an ionic separation process, a size exclusion separation process or combination thereof. The ionic and/or size exclusion separation processes may include, without limitation, an ionic membrane, ion exclusion chromatography, molecular weight and/or size exclusion chromatography or membrane, reverse osmosis, ultra-filtration membrane, membrane separation, gel membranes, leaky membranes or combinations. Preferably, the ionic and/or size exclusion separation processes separate one or more of the following from the remaining others: first reactant, second reactant, oxidization product of the first reactant, reduced product of the second reactant, first metal-solute species, and second metal-solute species. Preferably, the first metal-solute species is separated from the second metal-solute species. More preferably, the first metal-solute species is separated from the second metal-solute species, and separated first metal-solute species is supplied to the oxidation process and the separated second metal-species is supplied to the reduction process.

In some embodiments, the ionic and/or size exclusion separation processes may include separating the first metal-solution species from the second metal-solute species before transferring and/or returning at least one of the first and second metal-solution species to one of the oxidation or reduction solutions. Preferably, the separated first metal-solute species is transferred to the oxidation process and the separated second metal-solute species is transferred to the reduction process.

In other embodiments, the ionic and/or size exclusion separation processes may include separating the first or second reactant, respectively from the oxidized product of the first reactant or reduced product of the second reactant. The separated first reactant may be returned to the oxidation solution. Similarly, the separated second reactant may be returned to the reduction solution. One or both of the oxidized and reduced products may be retained for further processing, their economic value and/or for disposal.

Some embodiments may include a gas liquid separation process. The gas liquid separation process may include separating the any gas generated by one or both of the oxidation and reduction processes from one or both of the oxidation and reduction solutions. The gas liquid separation processes can include any process for separating and/or purifying a gas. Preferably, the gas separation process includes, without limitation, sparging processes, gas separating membranes (includes both metal and polymeric membranes), zeolites, gas absorption processes, gas dehydration process, pressure swing adsorption, or combinations thereof. Preferably, the gas liquid separation process separates and/or purifies one or both of the molecular hydrogen and molecular oxygen, respectively, formed in the oxidation and reduction processes.

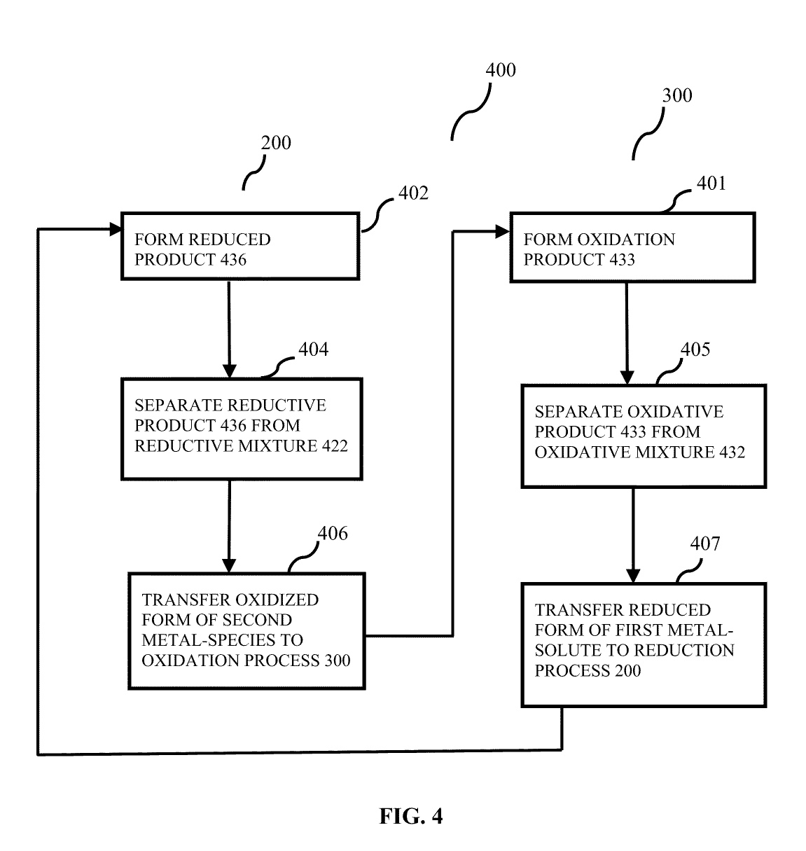

FIG. 4 depicts a method for carrying out a cyclic process 400. Preferably, the cyclic process 400 comprises the oxidation process 300 and reduction process 200. The oxidation 300 and reduction 200 processes are substantially conducted as described above.

In step 401, a first reactant 431 can be contacted with a first metal-solute species 412 and a catalyst 421 to form an oxidative product 433 and a reduced form of the first metal-solute species 434. Together, the first reactant 431, the first metal-solute species 412, and the catalyst 421 comprise oxidation mixture 432. The catalyst 421 and the first metal-solute species are, respectively, preferably one of the catalysts and first metal-solute species described above. Similarly, the reduced form of the first metal-solute species comprises the second metal-solute species described above. Step 401 can substantially comprise the oxidation process 300 of the cyclic process 400.

In a preferred embodiment, the first reactant 431 is water and the oxidative product 433 is gaseous molecular oxygen. Furthermore, the first metal-solute species is one of cerium (IV) sulfate and cerium (IV) methanesulfonate, respectively, in one sulfuric acid and methanesulfonic acid and the reduced form of first metal-solute species comprises one of cerium (III) sulfate and cerium (III) methanesulfonate.

Step 401 may optionally include applying thermal energy during at least some, if not most, of the oxidation process 300. The thermal energy is preferably applied to the oxidation mixture 432. It can be appreciated that some catalysts may not require applying thermal energy, while other catalysts may require applying at least some thermal energy.

In step 405, the oxidative product 433 can be separated from the oxidation mixture 432. Preferably, the separation process may include, without limitation, a positive, ambient or negative pressure bleeding off of the atmosphere above the oxidation mixture 432 to form a bleed-off stream. The molecular oxygen gas can be removed from the bleed-off stream by any process known within the art, such as, but not limited to liquid gas separation process described above to form a concentrated molecular oxygen stream 434 and an oxygen-deleted stream 435. The oxygen-deleted stream 435 may be returned to the oxidation process step 401 for further sweeping of the molecular oxygen from the oxidation mixture 432. The concentrated molecular oxygen stream 434 may be further processed, to further purify and/or concentrate the oxygen.

In step 407, the reduced form of the first metal-solute species is transferred to reduction process 200. Preferably, the reduced form of the first metal-solute species is transferred to the reduction process 200 of the cyclic process 400. More preferably, the reduced form of the first metal-solute species formed during the oxidation process 300 is transferred to step 402 of the reduction process 200.

Step 407 may further optionally include separating one or more of the catalysis 421, first metal-solute species 412, a transformed form of the first reactant 431 and reduced form of the first metal-solute species from the oxidative mixture 432. The transformed form of the first reactant refers to any material other than oxidized product formed by the oxidation of the first reactant 431 formed from the first reactant by the oxidation of the first reactant 431. The separating may comprise one or more of a physical solid liquid separation, an ionic separation, a size exclusion separation processes or a combination thereof. The separated-out catalysis 421 is preferably returned to the oxidative mixture 432 of step 401. Similarly, the separated-out first-metal solute species 412 is preferably returned to the oxidation mixture of step 401. The separated-out transformed form of the first reactant 431 is preferably further processed, sold, and/or disposed of.

In step 402, electromagnetic energy 442 can be applied to the reduction mixture 422 comprising a second reactant 424, and a second metal-solute species 426 to form a reduction product 436 and an oxidized form of the second metal-solute species 438. The oxidized form of the second metal-solute species 438 preferably comprises the first metal-solute species 412. Commonly, the reduced form the first metal-solute species comprises the second metal-solute species 424 formed in the oxidation process 300. Preferably, the second metal-solute species 424 is one of the metal-solute species indicated above. The electromagnetic energy 442 preferably comprises one of the wavelengths or wavelength ranges indicated above.

In some embodiments, the second metal-solute species is one of cerium (III) sulfate and cerium (III) methanesulfonate, respectively, in one sulfuric acid and methanesulfonic acid, the second reactant is a proton or a protonated form of water and the reductive product 436 is gaseous hydrogen. Preferably, the electromagnetic energy 442 comprises one or more wavelengths absorbed the second metal-solute species. More preferably, the electromagnetic energy 442 comprises one or more wavelengths absorbed by at least one of cerium (III) sulfate and cerium (III) methanesulfonate.

In step 404, the reductive product 436 can be separated from the reduction mixture 422. The separation process may include, without limitation, a positive, ambient or negative pressure bleeding off of the atmosphere above the reduction mixture 422 to form a bleed-off stream. The molecular hydrogen gas can be removed from the bleed-off stream by any one of more of the processes described above to form a concentrated molecular hydrogen stream and a hydrogen-deleted stream. The hydrogen-deleted stream may be returned to the reduction process 200 to further sweep molecular hydrogen from the reduction mixture 422.

In step 406, the oxidized form of the second metal-solute species is transferred to the oxidation process 300. Preferably, the oxidized form of the second metal-solute species is transferred to the oxidation process 300 of the cyclic process 400. More preferably, the oxidized form of the second metal-solute species formed during the oxidation process 300 is transferred to step 401 of the oxidation process 300. Even more preferably, the oxidized form of the second metal-solute species is the first metal-solute species 412.

Step 406 may further optionally include separating one or more of the second metal-solute species 426, a transformed form of the second reactant 426 and oxidized form of the second metal-solute species from the oxidative mixture 422. The transformed form of the second reactant 426 refers to any material other than reduction product formed by the reduction of the second reactant 426 formed from the second reactant 426 by the reduction of the second reactant 426. The separating comprises one or more of a physical solid liquid separation, an ionic separation, a size exclusion separation processes or a combination thereof. The second-metal solute species 424 that was separated-out is preferably returned to the reduction mixture of step 402. The transformed form of the second reactant 426 that was separated-out is preferably further processed, sold, and/or disposed of.

### EXAMPLES

### Example 1

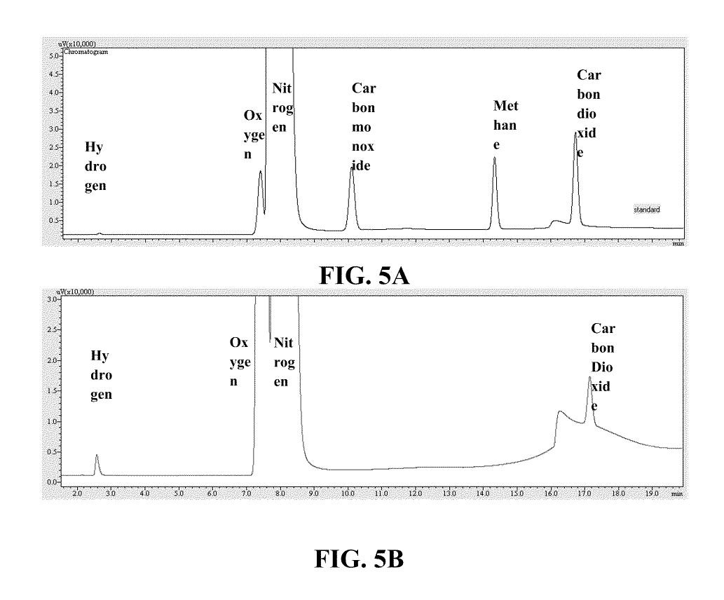

A clear, colorless solution of 0.15 M Ce₂(SO₄)₃ in 100 mL of 0.35 N sulfuric acid was placed in a ultra-violet light transparent quartz tube. A ultra-violet excimer laser having a wavelength of about 248 nm was pulsed about 14,000 times for about approximately 12 minutes. Each laser pulse had a duration of about 20 nanoseconds. The net laser irradiation time was about 288 microseconds. The laser beam was passed through the quartz tube. The application of the laser beam generated bubbles in the solution and produced a yellow color consistent with the formation of Ce (IV) sulfate. FIG. 5A is gas chromatography mass spectral analysis of the atmosphere above the solution prior to irradiation of the 0.15 M Ce₂(SO₄)₃ in 0.35 N sulfuric acid solution with the ultra-violet excimer laser, the atmosphere above the solution substantially lacks hydrogen. FIG. 5B is gas chromatography mass spectral analysis of the atmosphere above the solution 0.15 M Ce₂(SO₄)₃ of 0.35 N sulfuric acid after irradiation of the solution with the ultra-violet excimer laser, the atmosphere above the solution substantially comprises hydrogen gas.

### Example 2

A solution was formed by adding about 25 mL of 0.2 M Ce(SO₄)₂ to an Erlenmeyer flask with about 0.20 g of activated carbon having about 10 wt % nano-crystalline platinum loading (obtained from Sigma Aldrich). The nano-crystalline platinum loaded activated carbon had a surface area from about 10 to about 80 m²/g. The solution initially had a yellow color, characteristic of cerium (IV). The mixture was stirred in a water bath at a temperature of about 20° C. for about 30 minutes. Over this 30-minute period the mixture continually produced O₂ bubbles. At the end of this 30-minute period the solution was filtered, the filtrate was clear and colorless, which is consistent with cerous (III) sulfate being formed. The change in color from yellow to colorless is indicative of the reduction of Ce (IV) to Ce (III). The reaction produced oxygen gas at 20 degrees Celsius and in the absence of an applied electric potential.

### Example 3

A solution was formed by adding 50 mL of 0.01 M Ce(SO₄)₂ in 2 M H₂SO₄ to an erlenmeyer flask. The solution had a yellow color, indicative of cerium (IV). The solution was heated to a temperature of about 44° C. under magnetic stifling. To the heated solution, about 0.2 grams of Industrial Grade Multi-Walled Carbon Nanotubes (Sun Innovations, SN-5906837) were added and subsequently dispersed in the solution. After stifling for about 1 hour at temperature of about 44° C., the yellow solution became colorless, indicative of cerium (IIII). The process of example is consistent with the reduction of Ce(IV) to Ce(III).

### Example 4

A solution was formed by adding about 50 mL of 0.01 M Ce(SO₄)₂ in about 2 M H₂SO₄ to an erlenmeyer flask. The solution was heated to a temperature of about 44° C. under magnetic stirring. To the heated solution, about 0.4 grams of activated carbon powder (DARCO, Norit N.V.) were added to and dispersed in the solution. After stifling for about an hour at 44° C., the solution was filtered. The solution filtrate was colorless. The colorless filtrate is consistent with cerous (III) sulfate. The color change from yellow, Ce (IV), to colorless, Ce (III) is indicative with the reduction of Ce (IV) to Ce (III).

A number of variations and modifications of the disclosure can be used. It would be possible to provide for some features of the disclosure without providing others.

The present disclosure, in various aspects, embodiments, and configurations, includes components, methods, processes, systems and/or apparatus substantially as depicted and described herein, including various aspects, embodiments, configurations, subcombinations, and subsets thereof. Those of skill in the art will understand how to make and use the various aspects, aspects, embodiments, and configurations, after understanding the present disclosure. The present disclosure, in various aspects, embodiments, and configurations, includes providing devices and processes in the absence of items not depicted and/or described herein or in various aspects, embodiments, and configurations hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more, aspects, embodiments, and configurations for the purpose of streamlining the disclosure. The features of the aspects, embodiments, and configurations of the disclosure may be combined in alternate aspects, embodiments, and configurations other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed aspects, embodiments, and configurations. Thus, the following claims are hereby incorporated into this Detailed Description, with each claim standing on its own as a separate preferred embodiment of the disclosure.

Moreover, though the description of the disclosure has included description of one or more aspects, embodiments, or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A process, comprising:
contacting a metal-solute species with a catalyst, wherein the contacting of the catalyst with the metal-solute species forms molecular oxygen and a reduced form of the metal-solute species.

2. The process of claim 1, wherein the metal-solute species comprises one or more of Au³⁺, Pb²⁺, Pb⁴⁺, Ce⁴⁺, Pr⁴⁺, Er³⁺, Bk⁴⁺, and Cm⁴⁺.

3. The process of claim 1, wherein one or both of the metal-solute species and the reduced form of the metal-solute species comprise a sulfonate and wherein the metal-solute species comprises an aqueous solution.

4. The process of claim 3, wherein the sulfonate is selected from sulfate methanesulfonate and a mixture thereof.

5. The process of claim 1, wherein the metal-solute species comprises a cerium (IV)-containing sulfonate.

6. The process of claim 1, wherein the catalyst is an electron conductor.

7. The process of claim 1, wherein the catalyst is selected from the group consisting of a platinum group metal-containing material, activated carbon, carbon nano-tubes and a mixture thereof.

8. The process of claim 1, wherein the catalyst is a platinum group metal-containing material and wherein the catalyst has an average surface area from about 10 m²/g to about 100 m²/g.

9. The process of claim 1, wherein the catalyst comprises carbon nano-tubes having surface area greater than about 100 m²/g.

10. The process of claim 9, wherein the carbon nano-tube catalyst comprises single- or multi-walled nano-tubes.

11. The process of claim 10, wherein the carbon nano-tubes have an average tube diameter from about 5 to about 50 nm.

12. The process of claim 10, wherein the carbon nano-tubes have an average tube diameter from about 10 to about 30 nm.

13. The process of claim 1, wherein the catalyst comprises activated carbon.

14. The process of claim 13, wherein the activated carbon comprises a powder having an average surface area greater than about 1,000 m²/g.

15. The process of claim 14, wherein the activated carbon comprises a powder having an average surface area greater than about 1,500 m²/g.

16. The process of claim 1, wherein the process is conducted at a temperature of no more than about 50 degrees Celsius.

17. The process of claim 16, wherein the process is conducted at a temperature of no more than about 20 degrees Celsius.

18. The process of claim 1, wherein the reduced form the metal-solute species comprises one or more of Au⁺, Pb²⁺, Pb⁰, Ce³⁺, Pr³⁺, Er²⁺, Bk³⁺, and Cm³⁺.

19. The process of claim 18, wherein reduced form of the metal-solute species comprises one or both of cerium (III) sulfate and cerium (III) methanesulfonates.

20. A process, comprising:
applying electromagnetic energy having a wavelength from about 25 nm to about 1000 nm to a metal-solute solution to form molecular hydrogen and an oxidized form of the metal-solute solution, wherein at least some of the electromagnetic energy is absorbed by the metal-solute solution.

21. The process of claim 21, wherein the metal-solute species comprises one or more of Au⁺, Pb²⁺, Pb⁰, Ce³⁺, Pr³⁺, Er²⁺, Bk³⁺ and Cm³⁺.

22. The process of claim 20, wherein at least one of the metal-solute species comprises and the oxidized form of the metal-solute species comprises a sulfonate and the metal solute solution comprises an aqueous solution.

23. The process of claim 22, wherein the metal-solute species comprises one or both of a sulfate and methanesulfonate.

24. The process of claim 20, wherein the metal-solute species comprises cerium (III)-containing sulfonate.

25. The process of claim 24, wherein the cerium (III)-containing sulfonate comprises sulfuric acid, methanesulfonic acid or a mixture thereof.

26. The process of claim 20, wherein the wavelength of the electromagnetic energy is from about 100 to about 325 nm.

27. The process of claim 20, wherein a laser provides the electromagnetic energy.

28. The process of claim 20, wherein the oxidized form of the metal-solute species comprises one or more of Au³⁺, Pb²⁺, Pb⁰, Ce⁴⁺, Pr⁴⁺, Er³⁺, Bk⁴⁺, and Cm⁴⁺.

29. The process of claim 20, wherein the oxidized form of the metal-solute species comprises one or both of cerium (IV)-containing sulfonate and wherein the cerium (IV)-containing sulfonate comprises one sulfuric acid, methansulfonic acid or a mixture thereof.

30. A process, comprising:
contacting, in a first compartment, a first metal-solute species with a catalyst, wherein the contacting of the first metal-solute species with the catalyst forms molecular oxygen and a second metal-solute species, wherein the first metal-solute species is an oxidized form of the second metal-solute species;
contacting, in a second compartment containing, a plurality of photons with the second metal-solute species, wherein at least some of the photons are absorbed by the second metal-solute species to form hydrogen gas and the first metal-solute species;
providing the second metal-solute species formed in the first compartment to the second compartment; and
providing the first metal-solute species formed in the second compartment to the first compartment.

31. The process of claim 30, wherein first metal-solute species comprises a cerium (IV)-containing sulfonate aqueous solution selected from the group of sulfonates aqueous solutions consisting of sulfate, methanesulfonic acid and a mixture thereof and wherein second metal-solute species comprises a cerium (III)-containing sulfonate selected from the group of sulfonates consisting of sulfate, methanesulfonate and a mixture thereof.

32. The process of claim 30, wherein the catalyst is an electron conductor.

33. The process of claim 30, wherein the catalyst is selected from the group consisting of a platinum group metal-containing material, activated carbon, carbon nano-tubes, and a mixture thereof.

34. The process of claim 30, wherein the catalyst is a platinum group metal-containing material and wherein the catalyst has an average surface area from about 1 m²/g to about 200 m²/g.

35. The process of claim 30, wherein the catalyst comprises carbon nano-tubes and wherein the carbon nano-tubes have an average surface area greater than about 100 m²/g.

36. The process of claim 32, wherein the carbon nano-tubes comprise single- or multi-walled carbon nano-tubes.

37. The process of claim 36, wherein the carbon nano-tubes have an average tube diameter from about 1 to about 50 nm.

38. The process of claim 36, wherein the carbon nano-tubes have an average tube diameter from about 10 to about 30 nm.

39. The process of claim 30, wherein the catalyst comprises activated carbon.

40. The process of claim 39, wherein the activated carbon comprises a powder having an average surface area greater than about 1,000 m²/g.

41. The process of claim 39, wherein the activated carbon comprises a powder having an average surface area greater than about 1,500 m²/g.

42. The process of claim 30, further comprising:
separating the catalyst from the molecular oxygen before providing the second metal-solute to the second compartment.

43. The process of claim 30, wherein the process is conducted at a temperature no more than about 50 degrees Celsius.

44. The process of claim 43, wherein the process is conducted at a temperature no more than about 20 degrees Celsius.

45. The process of claim 30, wherein the contacting of the first metal-solute with the catalyst is at a temperature no greater than about 50 degrees Celsius.

46. The process of claim 45, wherein the contacting of the first metal-solute with the catalyst is at a temperature no greater than about 20 degrees Celsius.

47. The process of claim 30, wherein the plurality of photons have a wavelength from about 25 to about 1,000 nm.

48. The process of claim 47, wherein the plurality of photons have a wavelength from about 100 nm to about 400 nm.

49. The process of claim 47, wherein the plurality of photons have a wavelength from about 200 to about 300 nm.

50. The process of claim 30, further comprising one or both of:
removing the molecular oxygen gas formed in the first compartment from the first compartment; and
removing the molecular hydrogen formed in second compartment from the second compartment.

51. The process of claim 30, further comprising:
separating the molecular hydrogen from the second metal-solute species solution before providing the second metal-solute species to the first compartment.

52. A process, comprising:
contacting, in a first compartment, a cerium (IV)-containing sulfonate aqueous solution with a catalyst, wherein the contacting of the cerium (IV)-containing sulfonate solution with the catalyst forms oxygen gas and cerium (III);
providing, in a second compartment, a plurality of photons having a wavelength from about 200 to about 300 nm to a cerium (III)-containing sulfonate aqueous solution, wherein at least some of the photons are absorbed by the cerium(III)-containing sulfonate solution to form hydrogen gas and cerium (IV);
providing the cerium (III) formed in the first compartment to the second compartment; and
providing the cerium (IV) formed in the second compartment to the first compartment.
